(19) United States
(12) Patent Application Publication
(10) Pub. No.: US 2010/0300872 A1
(43) Pub. Date: Dec. 2, 2010

(54) Methods for Low Temperature Hydrogen Sulfide Dissociation

(75) Inventors: Alexander Gutsol, San Ramon, CA (US); R. William Potter, SR., Pleasanton, CA (US); Kirill Gutsol, Philadelphia, PA (US); Thomas Nunnally, Philadelphia, PA (US); Andrei Starikovskii, Marlton, NJ (US); Alexander Fridman, Marlton, NJ (US); Alexander Rabinovich, Cherry Hill, NJ (US)

Correspondence Address: Merchant & Gould - Chevron, PO Box 2903, Minneapolis, MN, 55402, US

(73) Assignees: Chevron U.S.A. Inc., San Ramon, CA (US); Drexel University, Philadelphia, PA (US)

(21) Appl. No.: 12/790,250

(22) Filed: May 28, 2010

Related U.S. Application Data
(60) Provisional application No. 61/182,867, filed on Jun. 1, 2009.

(51) Int. Cl. C01B 3/04; C01B 17/02

(52) U.S. Cl. 204/164; 423/573.1; 423/561.1

(57) ABSTRACT

A method of H₂S dissociation which comprises generating radicals or ions. The H₂S dissociation is initiated at relatively low temperature, e.g., of less than 1875 K. The residence time for dissociation generally ranges from about 0.01 s to 10 s. In one embodiment, plasmas are used to generate ions for use in the H₂S dissociation.

### BACKGROUND

Hydrogen sulfide, H₂S, is a byproduct of oil refinement. Therefore, efficient H₂S treatment and utilization is crucial to the oil and gas industry. In particular, H₂S dissociation into sulfur and hydrogen is commercially important for the oil and gas industry, which consumes large amounts hydrogen in oil hydrotreatment.

Rising fuel costs and more stringent restrictions on CO₂ emissions have resulted in increasing interest in the weakly endothermic process of H₂S dissociation, which can be arranged in a chemical or thermo-chemical reactor and carried out via the following reaction:

H₂S→H₂+S_{co}; ΔH₂₉₈=20.6 kJ/mole=0.213 eV/mol=0.255 kWh/m³ (1).

From the standpoint of thermodynamics, H₂S is a cost effective source of hydrogen, as the disassociation energy of H₂S is only 0.2 eV per molecule. Therefore, the possibility to dissociate H₂S into sulfur and hydrogen is important commercially. It has been estimated that if plasma dissociation of H₂S can be industrially realized with Specific Energy Requirement (SER) lower than 1 eV per H₂ molecule, the refining industry can save up to 70·10¹² Btu/yr.

Several plasma-chemical systems have been utilized for H₂S dissociation: microwave (MW) discharge, radio frequency (RF) discharge, gliding arc (GA) discharge, gliding arc in tornado (GAT), and a nitrogen plasma jet. Such plasma-chemical systems however, have significant drawbacks. Powerful MW systems are not readily available and are complicated and expensive. Both MW and RF discharges are difficult to arrange at relatively high pressure with the presence of hydrogen in the plasma. Scaling up of these systems is also problematic. GA and conventional arc discharges have relatively low efficiencies. GAT and conventional GA have potential problems with electrode deterioration and also problems with scaling. Dissociation in the nitrogen plasma jet also has relatively low efficiency and creates unnecessary byproducts (NH₃).

The existing theoretical basis for H₂S dissociation was developed in the 1980's, when detailed kinetic simulation was difficult because of low computational power. It was concluded that the process is defined by equilibrium heating. The traditional kinetic scheme of H₂S dissociation includes one endothermic reaction:

H₂S+M [symbol] SH+H+M; ΔH₂₉₈=379 kJ/mole=3.93 eV/mol (2)

which is the limiting reaction in the scheme, and several fast exothermic reactions:

H+H₂S [symbol] H₂+SH (3)

SH+SH [symbol] H₂+S₂ (4)

or

SH+SH [symbol] H₂S+S (5)

H₂S+S [symbol] H₂+S₂ (6).

As a result, it is necessary to spend 3.93 eV to dissociate two molecules of H₂S, which is equivalent to SER of hydrogen production at least 1.965 eV/mol. Thermodynamic equilibrium modeling with the assumption of plug flow reactor with fast product quencing shows the lowest SER that can be expected is 2.04 eV per molecule (see FIG. 1), which is achieved at 1875 K. Table 1 shows the composition of an equilibrium H₂S mixture at the point of minimum SER (species with mole fraction lower than 0.1% omitted).

TABLE 1

| Mixture Species | Mole Fraction (%) |
|---|---|
| H₂S | 21.99 |
| SH | 1.91 |
| H₂ | 50.98 |
| S₂ | 24.98 |

More efficient and effective processes for H₂S dissociation would therefore be of great benefit to the oil and gas industry.

### SUMMARY

Provided is a method of H₂S dissociation comprising generating radicals or ions, wherein H₂S dissociation is initiated at a relatively low temperature, e.g., of less than 1900° K, for example, less than 1875° K, or less than 1700° K.

In one embodiment, the process involves reactions with the accumulation of H₂S₂ as product and using a reaction chain that is triggered with a small amount of H and SH radicals. In another embodiment, plasma catalysis is used. Ions are produced in or introduced into a reaction zone of relatively low temperature. Positive and negative charges can be prevented from recombining by creating a DC corona discharge in the reaction zone, or by applying a biased voltage.

### BRIEF DESCRIPTION OF THE FIGURES OF THE DRAWING

FIG. 1 shows SER of dissociation per H₂S molecule as a function of energy input according to a thermodynamic equilibrium simulation with the assumption of plug flow reactor with fast product quenching.

FIG. 2 illustrates the presently disclosed chemical kinetics mechanism of H₂S dissociation and formation of H₂S₂ as a product.

FIG. 3 shows the modeling results of H₂S and H₂ mass fraction as a function of temperature.

FIG. 4 shows SER of dissociation as a function of energy input for thermodynamic equilibrium and kinetics modeling.

FIG. 5 is a diagram of a basic reactor schematic.

FIG. 6 is a diagram of a dissociation reactor with a heating element.

FIG. 7 is a diagram of a dissociation reactor with corona discharge.

FIG. 8 is a diagram of a dissociation reactor with glow discharge.

FIG. 9 is a diagram of a dissociation reactor with DC corona.

FIG. 10 is a diagram of a dissociation reactor with DC plasma and biased cylindrical wall.

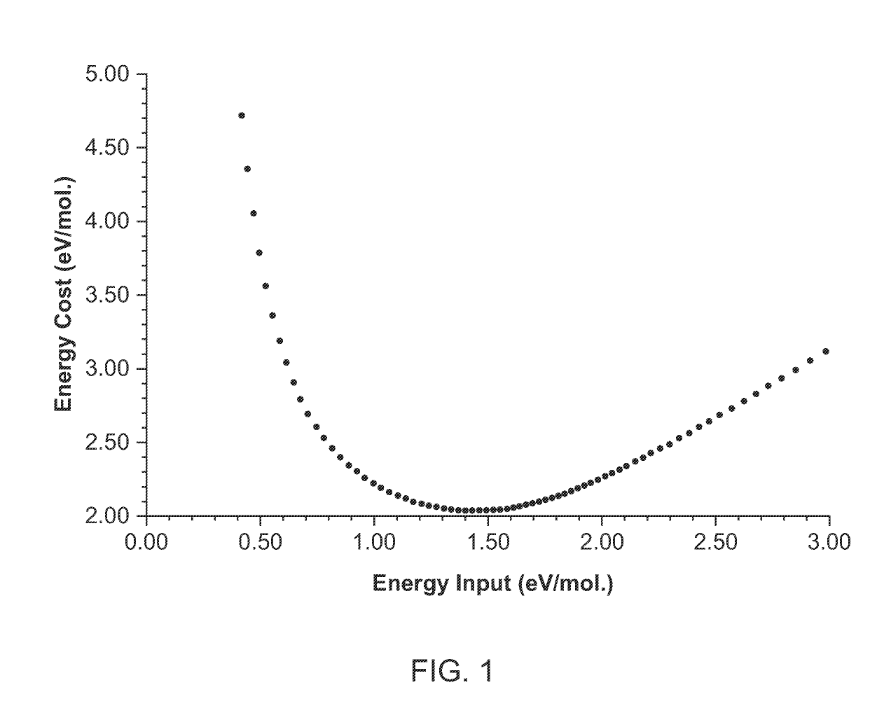

### DETAILED DESCRIPTION

Methods for H₂S dissociation are provided based on modeling and the analysis of high efficiency results obtained in MW, RF, and GAT systems. According to the presently disclosed methods, H₂S dissociation can be initiated at temperatures that are significantly lower than those that are needed to reach the minimum SER according to thermodynamic equilibrium modeling with the assumption of plug flow reactor.

The presently disclosed methods are based upon presently disclosed chemical kinetics mechanisms for H₂S dissociation that enable low temperature dissociation. One mechanism replaces the major dissociation product S₂ with H₂S₂, which can further release hydrogen and leave sulfur as a final product at lower temperatures. Other mechanisms involve molecular or cluster ions for plasma catalysis.

### Chemical Kinetics Mechanism

The presently disclosed chemical kinetics model shows the possibility of low SER for H₂S dissociation at temperatures that are significantly lower than in earlier models. The presently disclosed chemical kinetics mechanism, with a list of parameters, is shown in Table 2.

TABLE 2

| | A, cm³/ | | Eₐ, |
|---|---|---|---|
| Reaction | molecule · s | n | kcal/mole |
| H₂S + M [symbol] SH + H + M | 2.92E−08 | 0.00 | 66.21 |
| H₂S [symbol] H₂ + S | 3.16E−10 | 0.00 | 65.49 |
| H₂S + H [symbol] H₂ + SH | 2.31E−07 | 1.94 | 0.90 |
| H₂S + S [symbol] 2SH | 1.38E−10 | 0.00 | 7.392 |
| SH + S [symbol] H + S₂ | 4.00E−11 | 0.00 | 0.00 |
| SH + H [symbol] H₂ + S | 3.01E−11 | 0.00 | 0.00 |
| SH + SH [symbol] H₂ + S₂ | 1.00E−14 | 0.00 | 0.00 |
| SH + SH [symbol] H₂S + S | 1.50E−11 | 0.00 | 0.00 |
| SH + H₂S [symbol] H₂S₂ + H | 3.32E−10 | 0.50 | 27.00 |
| H₂S₂ + M [symbol] SH + SH + M | 3.43E−07 | 1.00 | 57.12 |
| S₂ + M [symbol] S + S + M | 7.95E−11 | 0.00 | 76.96 |
| S₂ + S₂ + M [symbol] S₄ + M | 2.23E−29 | 0.00 | 0.00 |
| H₂ + M [symbol] H + H + M | 3.70E−10 | 0.00 | 96.02 |
| HSS + HSS [symbol] H₂S₂ + S₂ | 3.46E−15 | 2.37 | −1.67 |
| HS + HSS [symbol] H₂S + S₂ | 3.66E−13 | 3.05 | −1.10 |
| H + HSS [symbol] S + H₂S | 7.32E−11 | 0.00 | 6.32 |
| H + HSS [symbol] H₂ + S₂ | 2.51E−12 | 1.65 | −1.10 |
| S + HSS [symbol] HS + S₂ | 2.00E−2 | 2.20 | −0.60 |

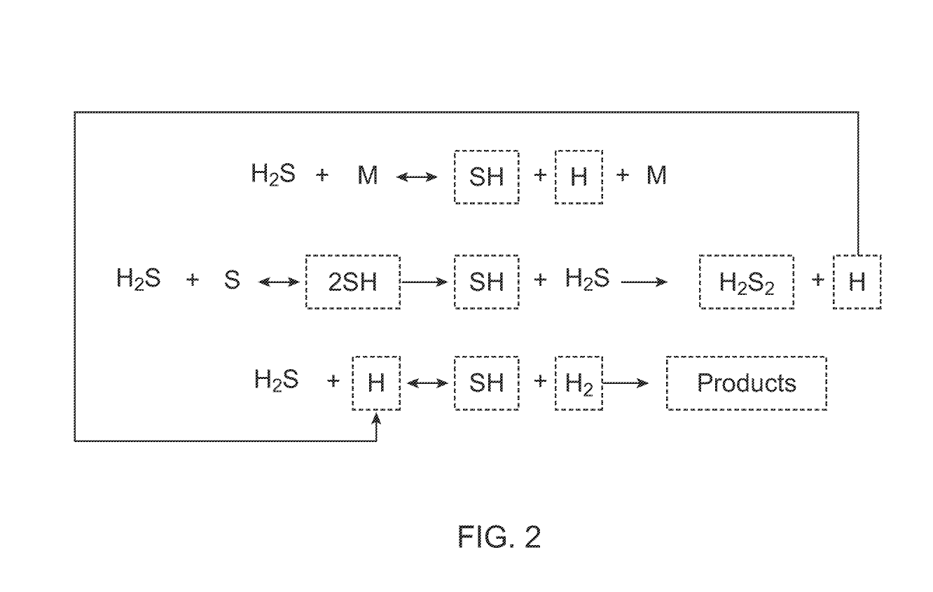

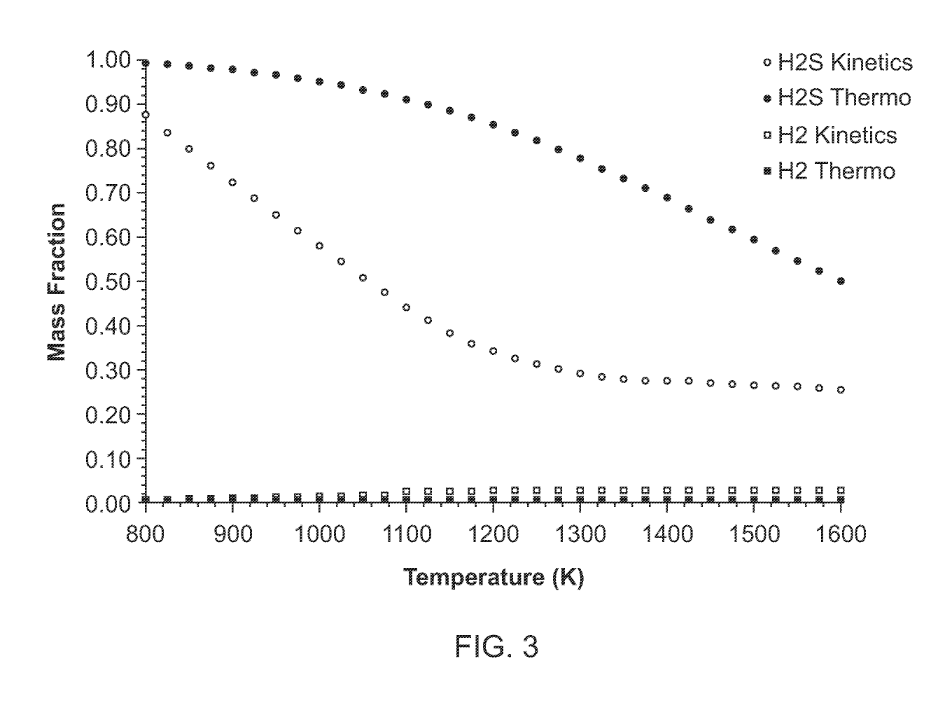

Main features of the presently disclosed chemical kinetics mechanism are accumulation of H₂S₂ as product and the reaction chain that is triggered with a small amount (˜1%) of H and SH radicals (see FIG. 2). Another main feature is that the process yields significantly higher degree of H₂S dissociation than the thermodynamic equilibrium modeling with the assumption of plug flow reactor with fast product quenching. The modeling results of dependence of mixture composition from the initiation temperature are illustrated in FIG. 3.

The thermodynamic equilibrium mixture composition is also shown for comparison. The modeling was performed on Chemkin® 4.1.1 software suite using a single adiabatic plug flow reactor with the initial mixture composition kept constant at 98% H₂S, 1% SH, and 1% H.

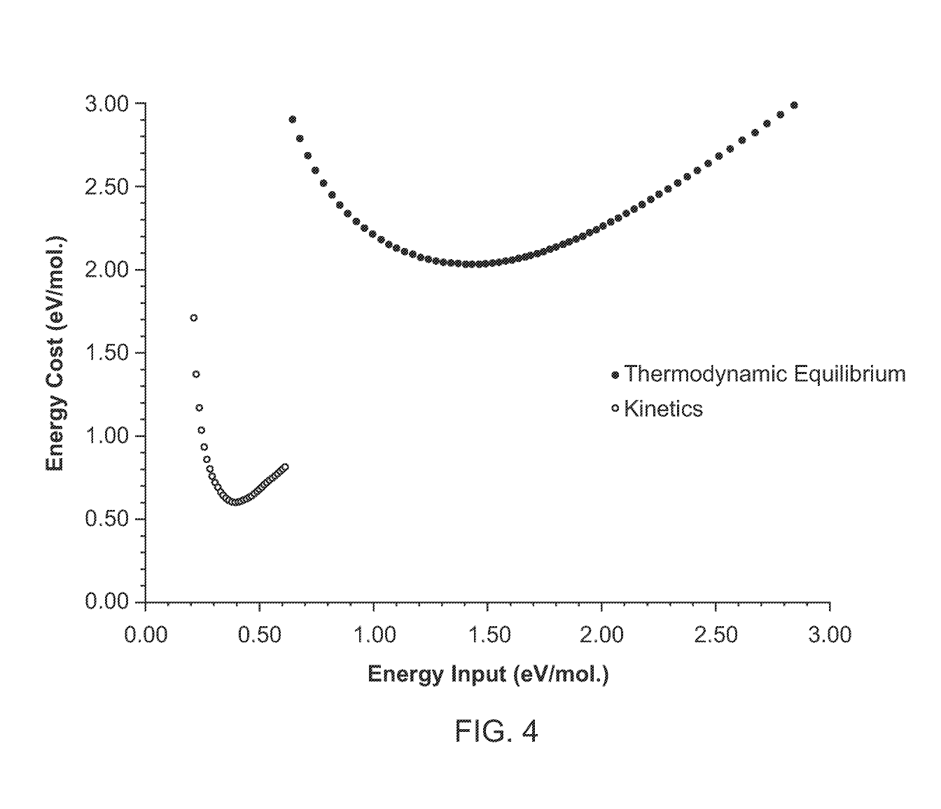

The above features contribute to the very low SER of H₂S dissociation using the presently disclosed chemical kinetics mechanism. The minimum SER corresponding to the initiation temperature of 1175K is 0.609 eV/mol, which is more than three times lower than minimum SER predicted by thermodynamic equilibrium modeling with the assumption of plug flow reactor with fast product quenching. A comparison of the results from both kinetics and thermodynamic equilibrium modeling is shown in FIG. 4. H₂S₂ should be considered as a final product of gaseous phase kinetics. Further dissociation of sulfanes (H₂Sₙ) with hydrogen and sulfur release takes place at much lower temperatures in the condensed phase.

The presently disclosed chemical kinetics mechanism shows significant improvement over previous models (e.g., conventional thermodynamic equilibrium model with the assumption of plug flow reactor with fast product quenching) and provides a potential explanation for the low dissociation SER observed in MW, RF, and GAT experiments, in which energy consumption was half of the SER=2.04 eV per molecule expected according to conventional thermodynamic equilibrium modeling with the assumption of plug flow reactor with fast product quenching.

H₂S dissociation at low temperatures is possible and leads to significantly higher dissociation rate than in previous models. H₂S dissociation at low temperatures requires rather long residence time ranging from 0.01 to 10 seconds (s), for example, from 0.1 to 1 s, depending on the temperature of the process. The residence time drops sharply with temperature increase.

### Plasma-Catalytic Mechanism

Another presently disclosed mechanism involves so-called plasma catalysis. The simplest example is an introduction of the ion-molecular reactions (that usually do not have any energy barriers)

H₂S+S₂⁻¹→H+S₂+SH⁻¹; ΔH₂₉₈=316 kJ/mol=3.28 eV/molec (7)

SH+SH⁻¹→H₂+S₂⁻¹; ΔH₂₉₈=−89.2 kJ/mol=−0.925 eV/molec (8)

together with reaction (3) allows to decrease the enthalpy of the limiting reaction (compare reactions (7) and (2)).

Much more significant decrease of the reaction temperature can be expected if it is assumed that negatively or positively charged sulfur clusters play a catalysis role for the gross reaction (1), for example:

Sₙ⁻¹+H₂S→H₂+Sₙ₊₁⁻¹; ΔH₂₉₈≦20.6 kJ/mol=0.213 eV/molec=0.255 kW-h/m³ (9).

While there is no available data to estimate possible rate and efficiency of this reaction, a similar reaction plays a key role in the mechanism of Si nano-particles formation in SiH₄—Ar plasma. Therefore, non-equilibrium plasma processes may play key roles in effective H₂S dissociation, and reaction control should be possible through the control of plasma parameters.

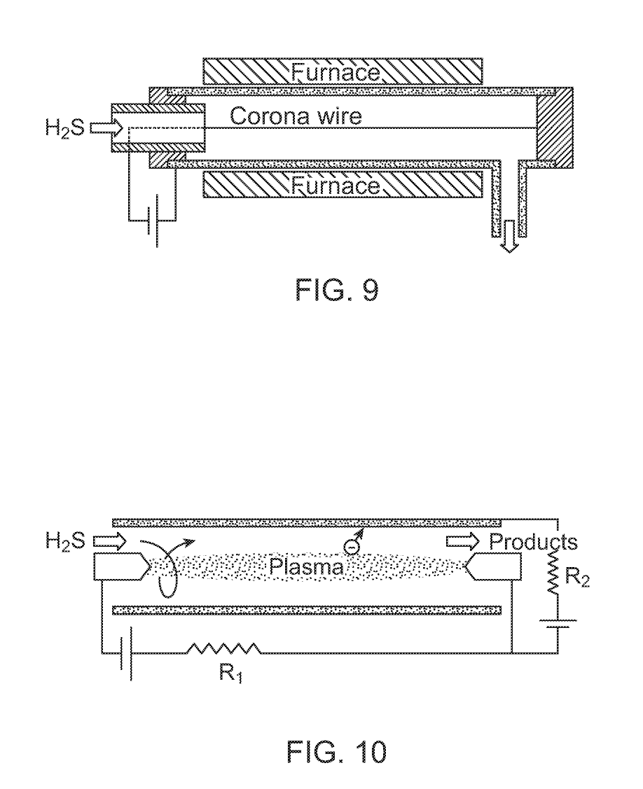

For effective realization of this mechanism it is necessary to produce ions in (or introduce into) the zone of relatively low temperature where the reaction (9) is much faster than the reverse reactions. Also it is important to separate positive and negative charges to prevent their fast recombination. This can be arranged, for example, by creating DC corona discharge in the reaction zone (FIG. 9) or by applying biased voltage between central plasma zone and a cylindrical wall (FIG. 10).

### Apparatus and Method for Low Temperature H₂S Dissociation

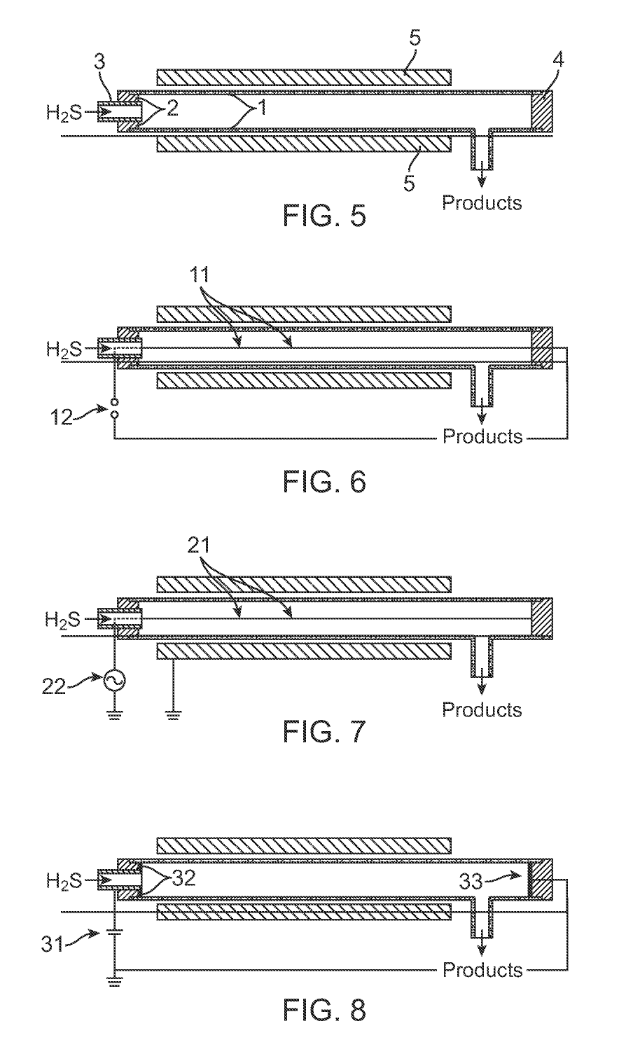

Based on the presently disclosed numeric modeling results and analysis of the presently disclosed plasma-catalytic mechanisms, there are several ways of organizing an H₂S dissociation reactor (see FIGS. 5-10). For most cases, a reactor will operate with the following general parameters: relatively low reaction zone temperature (less than 1900° K, in particular, less than 1875° K, for example, less than 1700° K), long residence time (from 0.01 to 10 s, for example, from 0.1 to 1 s), and a low power dissociation source for generation of H and SH radicals or ions. The first two parameters are common for all the reactors and can be organized almost identically for all the reactors. The dissociation source is the main factor distinguishing the reactors and requires significant changes from one reactor to another.

The long residence time in the reactor can be achieved by extending the length of the reaction zone proportionally with desired operational flow rates. For example, the laboratory size reactor designed to operate at 1 l/min of pure H₂S can have the reaction (hot) zone of 1 m with a residence time of 1 s, which corresponds to cross-section of 0.167 cm² or, in the case of cylindrical reactor, the diameter of 0.46 cm. Such system, even under laboratory conditions, can be scaled to accept 10 times higher flow rate by increasing the diameter of the reactor a little more than 3 times to 1.45 cm.

The uniform temperature of the mixture in the range from 800° K to 1700° K can be maintained throughout the reaction zone by heating the reaction zone externally with a convenient and efficient power source, e.g., heat exchanger, or by mixing with hot hydrogen. For example, a high quality tube furnace can be used for this purpose (FIGS. 5-9). Still, special care should be taken while choosing the main reaction chamber due to the heating requirements.

For example, the reaction tube can be made out of quartz or ceramic, which share high melting temperature, and both can be used as a dielectric, which is one of the requirements for the local dissociation source. FIG. 5 shows a general schematic of a simple plug-flow reactor with external furnace and without local dissociation source comprising reactor tube 1, inlet flange 2, inlet 3, closed end flange 4, and heating elements 5.

Several types of the reactors (FIGS. 6-9) can be distinguished based on the type of the source that is used for local H₂S dissociation. Even though some of the reactors have significantly different underlying principles, all of the reactors share a low power requirement. In general, power for the local dissociation should not exceed 50%, for example, 10%, of total power of the process local dissociation plus external heating. Low current less than 5 A, e.g., less than 1 A, arc or glow discharge is also appropriate at pressures between 0.01 MPa and 1 MPa.

The concept of radical production through localized heating is based on the presently disclosed chemical kinetics mechanism, but with the consideration that relatively high temperatures (of less than 2000° K, in particular, less than 1875° K) are reached in a very small volume with minimal energy input. Such high temperatures allow for very fast (one to two orders of magnitude faster than in the rest of the reactor volume) H₂S dissociation on H and SH radicals or generation of ions that sequentially trigger the chain reactions in the entire volume of the reactor. FIG. 6 shows a schematic of a reactor based on localized heating comprising high temperature heating element 11 (hot wire) and power supply 12. Other sources of radicals, e.g., small hydrogen dissociator or hydrogen plasma injection can be used.

A possible plasma source for low power radical production is corona discharge. It is organized along a thin conductive wire placed along the axis of the reactor. The physical properties of the wire are important due to the relatively high temperatures that the wire will be exposed to. It is recommended to use thin (˜0.25 mm) molybdenum wire, which has both very high melting point (2896° K), low thermal expansion coefficient (4.8 μm·m⁻¹·°K⁻¹), and does not react with H₂S. Still a certain care should be taken to prevent the exposure of the molybdenum wire to oxygen containing mixtures (e.g., air) at the temperatures exceeding 700° C. because fast oxidation reaction happens at 760° C. FIG. 7 shows a schematic of a dissociation reactor with Alternative Current (AC) corona discharge comprising high voltage power supply 21 and conductive wire 22.

Another possible plasma source for low power radical production is glow discharge. It is organized between high voltage cathode and grounded anode, which are located on the flanges of the reactor tube. Unlike the corona discharge, there are no strict physical requirements on the anode and cathode materials as they are located outside of the heating zone, but some non-corrosive metal is recommended (e.g., stainless steel) due to constant exposure of both electrodes to H₂S. The major requirement for glow discharge is low pressure that has to be maintained on the level of 10 Torr or less. FIG. 8 shows a schematic of a dissociation reactor with glow discharge comprising high voltage power supply 31, cathode 32, and anode 33. It is possible to use other plasma sources, like dielectric barrier discharge, pulsed corona, micro-discharges, etc. FIG. 10 demonstrates the use of low-current arc or atmospheric pressure DC glow discharge (similar to that used in Gliding Arc Tornado reactor). Plasma can be generated inside H₂S gas, or separately (e.g., discharge in hydrogen or in gaseous sulfur) with further injection into H₂S gas.

The reactor presented in FIG. 10 is similar to that presented in FIG. 9, however it use DC discharge combined with the biased voltage instead of corona. In that case ions generated inside the discharge can promote dissociation outside the discharge zone using ionic catalysis.

It is possible to combine key features of the disclosed relatively low-temperature reactors with additional features like product separation, e.g., separating hydrogen and sulfur, using, for example, centrifugal forces (gas or reactor rotation) or electrical forces (e.g., radial electric field for separation of charge clusters). Also, the presently disclosed processes can be realized inside a system with effective thermal energy recuperation, e.g., the reverse-vortex reactor. High energy efficiency of H₂S dissociation can be accomplished with a GAT reactor, which is an example of a relatively low-temperature reactor with generation of radicals and ions. GAT reactors utilize a gliding arc plasma discharge in reverse vortex flow. The GAT, like many other plasma discharges, can be used as a volumetric catalyst in various chemical processes. Some main features that make the GAT attractive are that it ensures uniform gas treatment and it has rather long residence times. Also, the reverse vortex flow creates a low temperature zone near the cylindrical wall of the reactor and a high temperature zone near the reactor axis. This, in combination with a centrifugal effect, allows sulfur extraction from the high temperature zone to the low temperature zone. As a result, sulfur quenching can occur within the reactor. Since H₂S is quite susceptible to plasma decomposition, GAT is not only a viable method but may also be a cost-effective method for H₂S dissociation. Further details of the GAT can be found in U.S. Patent Application Publication 2006/0266637, the contents of which are hereby incorporated by reference in their entirety.

Accordingly, provided is a method of H₂S dissociation comprising providing a plasma reactor. The plasma reactor comprises a wall defining a reaction chamber; an outlet; a reagent inlet fluidly connected to the reaction chamber for creating a vortex flow in the reaction chamber; a first electrode; and a second electrode connected to a power source for generation of a sliding arc discharge in the reaction chamber. The method further comprises introducing H₂S into the reaction chamber in a manner which creates a vortex flow in the reaction chamber and dissociating the H₂S using a plasma assisted flame.

In the method, the vortex flow can be a reverse vortex flow, which can be created by feeding H₂S into the reaction chamber in a direction tangential to the wall of the reaction chamber. The plasma reactor can comprise first and second ends, the reagent inlet can be located proximate to the first end, the reactor can further comprise a second inlet fluidly connected to the second end of the reactor, and at least some of the H₂S can be provided to the reaction chamber via the second inlet. The plasma reactor can comprise a movable second electrode and the method can further comprise the steps of igniting an electrical arc with the movable second electrode in a first position, and moving the movable second electrode to a second position farther from the first electrode than the first position for operation of the reactor.

While various embodiments have been described, it is to be understood that variations and modifications may be resorted to as will be apparent to those skilled in the art. Such variations and modifications are to be considered within the purview and scope of the claims appended hereto.

1. A method of H₂S dissociation comprising generating radicals or ions in a reaction zone and adding H₂S to the reaction zone to initiate H₂S dissociation at a temperature of less than 1900 K.

2. The method of claim 1, wherein H₂S dissociation is initiated at a temperature of less than 1875 K.

3. The method of claim 1, wherein H₂S dissociation is initiated at a temperature of less than 1700 K.

4. The method of claim 1, comprising maintaining a temperature of 800 K to 1700 K.

5. The method of claim 1, wherein the method comprises a residence time of 0.01 to 10 s.

6. The method of claim 1, wherein the method comprises a residence time of from 0.1 to 1 s.

7. The method of claim 1, wherein the radicals or ions comprise H and SH.

8. The method of claim 1, wherein radicals or ions are generated using corona discharge.

9. The method of claim 1, wherein radicals or ions are generated using glow discharge.

10. The method of claim 1, wherein radicals or ions are generated using dielectric barrier discharge, pulsed corona, or micro-discharges.

11. The method of claim 1, comprising using a gliding arc in a tornado reactor.

12. The method of claim 1, comprising using a low current <5 A arc or glow discharge at pressures between 0.01 MPa and 1 MPa.

13. The method of claim 1, wherein H₂S dissociation results in formation of H₂S₂.

14. The method of claim 1, wherein a plasma is used to create ions.

15. The method of claim 14, wherein the ions are negatively charged sulfur ions.

16. The method of claim 14, wherein a DC glow discharge is combined with a biased voltage to create the ions.

17. The method of claim 14, wherein the residence time in the reaction zone ranges from about 0.01 to 10 s.

18. The method of claim 17, wherein the residence time in the reaction zone ranges from about 0.01 to 1.0 s.

19. A method of H₂S dissociation comprising:
providing a plasma reactor, said plasma reactor comprising:
a wall defining a reaction chamber;
an outlet;
a reagent inlet fluidly connected to the reaction chamber for creating a vortex flow in said reaction chamber;
a first electrode; and
a second electrode connected to a power source for generation of a sliding arc discharge in the reaction chamber;
introducing H₂S into said reaction chamber in a manner which creates a vortex flow in the reaction chamber; and
dissociating said H₂S using a plasma assisted flame to create ions, with the dissociation being initiated at a temperature of less than 1900 K.

20. The method of claim 19, wherein the residence time in the reaction chamber for dissociation ranges from about 0.01 to 10 s.

21. The method of claim 20 wherein the residence time in the reaction chamber for dissociation ranges from about 0.1 to 1.0 s.

22. The plasma reactor of claim 19, wherein said vortex flow is a reverse vortex flow.

23. The method of claim 22, wherein said reverse vortex flow is created by feeding H₂S into said reaction chamber in a direction tangential to the wall of said reaction chamber.

24. The method of claim 23, wherein said plasma reactor comprises first and second ends, the reagent inlet is located proximate to the first end, the reactor further comprises a second inlet fluidly connected to the second end of said reactor, and wherein at least some of said H₂S is provided to the reaction chamber via the second inlet.

25. The method of claim 24, wherein the plasma reactor comprises a movable second electrode and said method further comprises the steps of igniting an electrical arc with said movable second electrode in a first position, and moving the movable second electrode to a second position farther from said first electrode than said first position for operation of said reactor.
